(19) United States
(12) Patent Application Publication
(10) Pub. No.: US 2003/0118196 A1
(43) Pub. Date: Jun. 26, 2003

(54) Wireless digital audio system

(76) Inventor: C. Earl Woolfork, Altadena, CA (US)

Correspondence Address: Dennis W. Beech, LAW OFFICES OF DENNIS W. BEECH, Suite C-2, 19900 Beach Blvd., Huntington Beach, CA, 92648, US

(21) Appl. No.: 10/027,391

(22) Filed: Dec. 21, 2001

(51) Int. Cl. H04R 1/10; H04R 5/02

(52) U.S. Cl. 381/74; 381/311

(57) ABSTRACT

The present invention is directed to wireless digital audio systems for transmission of a signal from an audio player device to a headphone. An audio transmitter may include a headphone plug in communication with an analog low pass filter wherein the headphone plug may be connectable to a headphone jack of an audio source. The low pass filter output signal may be in communication with an A/D converter whose output may be in communication with a digital low pass filter that outputs a signal to an encoder. The encoder output may be in communication with a channel encoder the output of which may be in communication with a block interleaver. The block interleaver output may be in communication with a modulator the output of which may be summed with a transmitter code generator output in a summating element. The modulator may be a 64 Ary modulator. The summating element output may be in communication with a differential phase shift key transmitter the output of which may be in communication with a transmit antenna for wireless transmission of a signal. The transmitted signal may be transmitted to an audio receiver for processing to power a headphone speaker. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims.

### BACKGROUND OF THE INVENTION

This invention relates to audio player devices and more particularly to systems that include headphone listening devices. The new audio system uses existing audio player device headphone jacks to connect a transmitter for wireless transmission of a signal to a receiving headphone.

Use of audio headphones with audio player devices such as radio, tape players, CD players, computers, television audio and the like have been in use for may years. Such use includes the portable player systems such as cassette tape players that may be used during exercising as for example running. These systems usually incorporate an audio source having a headphone jack to which a headphone is connected by wire and connector.

There are also known wireless headphones that may receive radio transmissions. Also, audio player devices have been modified to allow wireless communication with a headphone receiver. However, these systems do not allow use of a simple plug in transmitter for connection to the audio player device jack for wireless transmission between space separated devices.

As can be seen, there is a need for a simple connection system for existing audio player devices to allow wireless transmission to a headphone receiver.

### SUMMARY OF THE INVENTION

The present invention is directed to wireless digital audio systems for transmission of a signal from an audio player device to a headphone. An audio transmitter may include a headphone plug in communication with an analog low pass filter wherein the headphone plug may be connectable to a headphone jack of an audio source. The low pass filter output signal may be in communication with an A/D converter whose output may be in communication with a digital low pass filter that outputs a signal to an encoder. The encoder output may be in communication with a channel encoder the output of which may be in communication with a block interleaver. The block interleaver output may be in communication with a modulator the output of which may be summed with a transmitter code generator output in a summating element. The modulator may be a 64 Ary modulator. The summating element output may be in communication with a differential phase shift key transmitter the output of which may be in communication with a transmit antenna for wireless transmission of a signal. The transmitted signal may be transmitted to an audio receiver for processing to power a headphone speaker.

These and other features, aspects and advantages of the present invention will become better understood with reference to the following drawings, description and claims.

### BRIEF DESCRIPTION OF THE DRAWINGS

FIG. 1 illustrates a schematic diagram representation of the wireless digital audio system;

FIG. 2 illustrates a functional block diagram of the audio transmitter according to an embodiment of the invention;

FIG. 3 illustrates a functional block diagram of the audio receiver according to an embodiment of the invention.

### DETAILED DESCRIPTION

The following detailed description is the best currently contemplated modes for carrying out the invention. The description is not to be taken in a limiting sense, but is made merely for the purpose of illustrating the general principles of the invention.

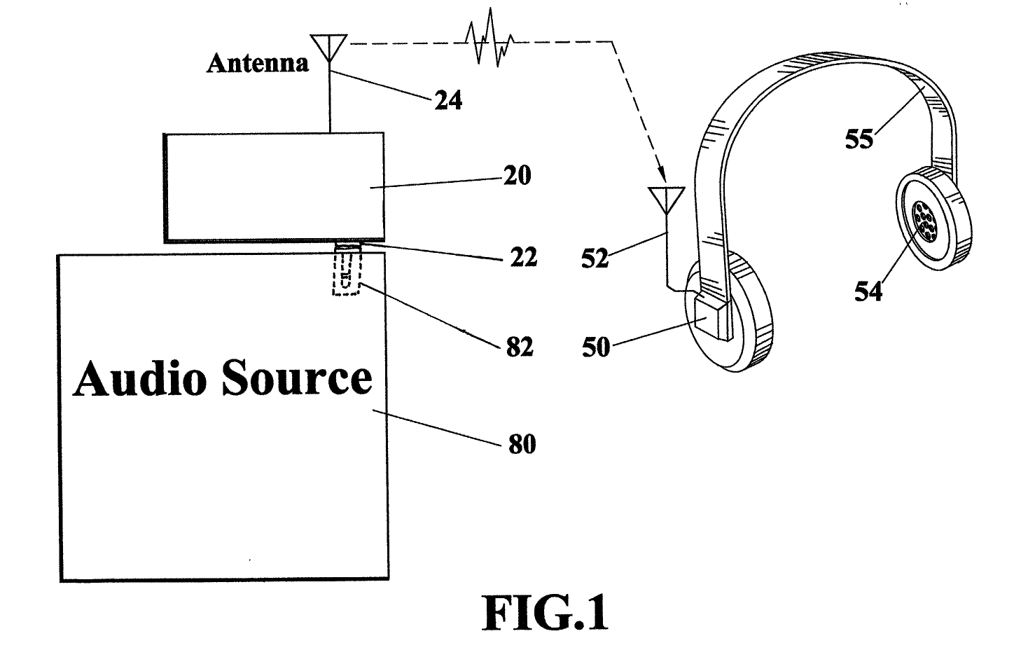

Referring to FIG. 1, a wireless digital audio system 10 may include an audio transmitter 20 connected to an audio player or audio source 80. The audio transmitter 20 may be connected to the audio source 80 headphone jack 82 using a headphone plug 22. The audio transmitter 20 may have a transmitting antenna 24 that may be omni-directional for transmitting an electromagnetic signal to a receiving antenna 52 of an audio receiver 50 that may be a headphone receiver. The audio receiver 50 may have headphone speakers 54 in headphones 55 for listening to the audio signal. The audio system 10 may digitize the audio signal and may transmit an electromagnetic signal at 2.4 GHz using approximately 100 milliwatts or less of power.

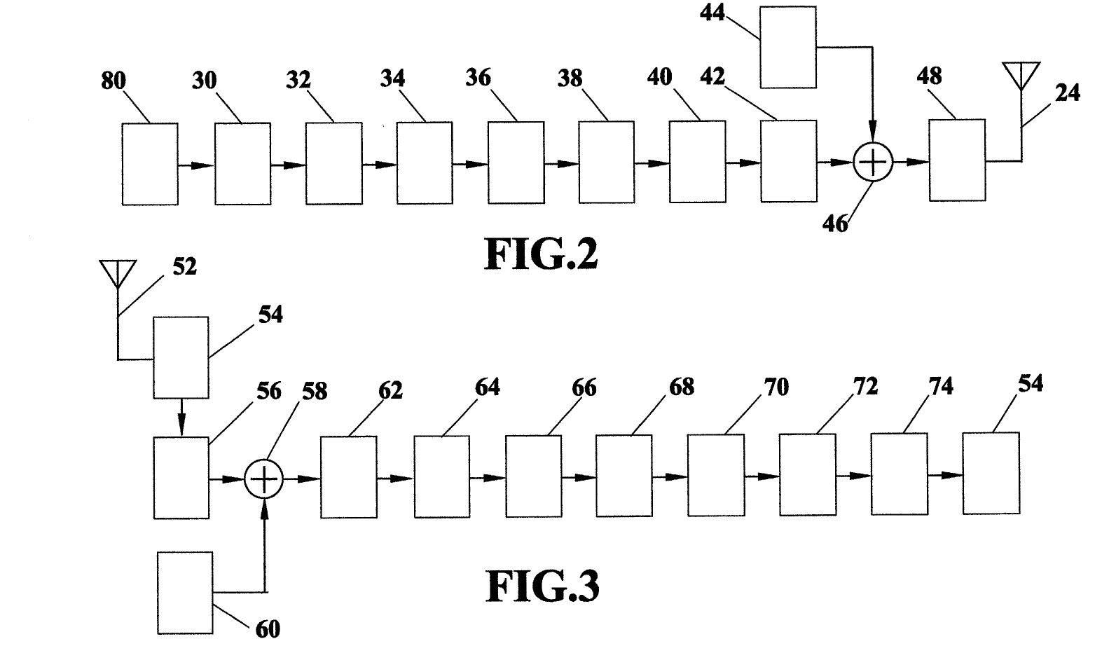

Referring to FIG. 2, an audio transmitter 20 may receive an audio signal from an audio source 80. The audio transmitter 20 may be a compact device that may be connected to the audio source 80 to remain therewith for transmitting a signal to an audio receiver. An audio source 80 normally provides an analog output signal in the approximate range of 20 Hz to 20 kHz. This signal may then be processed through an analog low pass filter 30 to then be digitized by a 4 bit analog-to-digital (A/D) converter 32. After digital conversion of the analog audio signal, the digital signal may be processed by a digital low pass filter 34 to reduce unwanted out of band noise that may have been produced by the A/D converter 32.

An encoder 36 may be used to reduce intersymbol interference (ISI) by using a transform code to encode the digital signal. The reduction of ISI may lower the probability of a signal detection error in the audio receiver. The digital signal may next be processed by a channel encoder 38 and a block interleaver 40 to produce encoded redundancies in the transmitted signal to reduce errors that may occur during transmission.

Modulation of the digital signal may be performed using direct sequence spread spectrum communication technology. A 64-Ary modulator 42 may be used for summation at summation element 46 with a transmitter code generator 44 signal to produce a high symbol rate, and a unique codeword that spreads the signal spectrum. The output of the summation element 46 may then be communicated to a differential phase shift key (DPSK) transmitter 48 that modulates the digital signal to be transmitted by an omni-directional transmitting antenna 24 at approximately 2.4 GHz. The transmit power may be limited to 100 milliwatts.

The transmitted signal from transmit antenna 24 may be received by receiving antenna 52 and communicated to a wideband band pass filter (BPF) 54. The received spread spectrum signal may then be communicated to a 2.4 GHz direct conversion receiver 56. The direct conversion receiver 56 may provide a method for down converting the received signal while utilizing timing and synchronization to capture the correct bit sequence embedded in the received spread spectrum signal. The audio receiver 50 may utilize fuzzy logic (or continuous logic) to optimize performance of the audio receiver 50.

The down converted output signal of the direct conversion receiver 56 may be summed in receiver summing element 58 with a receiver code generator 60 signal. The receiver code generator 60 may contain the same unique code word that was transmitted by the audio transmitter 20 specific to a particular a user. Other code words from wireless digital audio systems 10 may appear as noise to a particular audio receiver 50. This may also be true for other device transmitted signals operating in the wireless digital audio system 10 spectrum. This code division multiple access (CDMA) may be used to provide each user independent operation.

The resulting summed digital signal from receiving summary element 58 may be processed by a 64-Ary demodulator 62 to demodulate the signal elements modulated in the audio transmitter 20. A block de-interleaver 64 may then decode the bits of the digital signal encoded in the block interleaver 40. Following such, a Viterbi decoder 66 may be used to decode the bits encoded by the channel encoder 38 in the audio transmitter 20. A source decoder 68 may further decode the coding applied by the encoder 36. The resultant processed digital signal may thereby be condition to represent the original signal processed and transmitted by the audio transmitter 20.

The next step may process the digital signal to return the signal to analog or base band format for use in powering a speaker 54. A digital-to-analog converter 70 (DAC) may be used to transform the digital signal to an analog audio signal. An analog low pass filter 72 may be used to filter the analog audio signal to pass a signal in the approximate 20 Hz to 20 kHz frequency range and filter other frequencies. The analog audio signal may then be processed by a power amplifier 74 that may be optimized for powering a headphone speaker 54 to optimize a high quality, low distortion signal for hearing by a user wearing the headphones 55.

While the invention has been particularly shown and described with respect to the illustrated and preferred embodiments thereof, it will be understood by those skilled in the art that the foregoing and other changes in form and details may be made therein without departing from the spirit and scope of the invention.

I claim:

1. An audio transmitter for wireless transmission of a signal from an audio source to a headphone comprising:
a headphone plug in communication with an analog low pass filter and connectable to a headphone jack of an audio source;
said low pass filter output in communication with an A/D converter;
said A/D converter in communication with a digital low pass filter, the output of which is in communication with an encoder;
said encoder output in communication with a channel encoder the output of which is in communication with a block interleaver;
said block interleaver output in communication with a modulator the output of which is summed with a transmitter code generator output in a summing element; and
said summing element output in communication with a differential phase shift key transmitter the output of which is in communication with a transmit antenna for wireless transmission of a signal.

2. The audio transmitter as in claim 1 wherein said signal is transmitted to an audio receiver of said headphone comprising:
a receiving antenna in communication with a wideband band pass filter;
said wideband band pass filter in communication with a direct conversion receiver the output of which is summed with a receiver code generator in a receiver summing element;
said receiver summing element in communication with a demodulator the output of which is in communication with a block de-interleaver;
said block de-interleaver output in communication with a Viterbi decoder the output of which is in communication with a source decoder;
said source decoder output in communication with a D/A converter the output of which is in communication with an analog low pass filter; and
said analog low pass filter output in communication with a power amplifier the output of which is in communication with a headphone speaker.

3. The audio transmitter as in claim 1 wherein said modulator is a 64-Ary modulator.

4. The audio transmitter as in claim 2 wherein said demodulator is a 64 Ary demodulator.

5. An audio receiver for packaging in a headphone comprising:
a receiving antenna in communication with a wideband band pass filter;
said wideband band pass filter in communication with a direct conversion receiver the output of which is summed with a receiver code generator in a receiver summing element;
said receiver summing element in communication with a demodulator the output of which is in communication with a block de-interleaver;
said block de-interleaver output in communication with a Viterbi decoder the output of which is in communication with a source decoder;
said source decoder output in communication with a D/A converter the output of which is in communication with an analog low pass filter; and
said analog low pass filter output in communication with a power amplifier the output of which is in communication with a headphone speaker.

6. The audio receiver as in claim 5 wherein said demodulator is a 64 Ary demodulator.

7. A wireless digital audio system for wireless transmission of a signal from an audio source to a headphone comprising:
a headphone plug in communication with an analog low pass filter and connectable to a headphone jack of an audio source;
said low pass filter output in communication with an A/D converter;
said A/D converter in communication with a digital low pass filter, the output of which is in communication with an encoder;
said encoder output in communication with a channel encoder the output of which is in communication with a block interleaver;
said block interleaver output in communication with a modulator the output of which is summed with a transmitter code generator output in a summing element;
said summing element output in communication with a differential phase shift key transmitter the output of which is in communication with a transmit antenna for wireless transmission of a signal to a receiving antenna;
said receiving antenna in communication with a wideband band pass filter;
said wideband band pass filter in communication with a direct conversion receiver the output of which is summed with a receiver code generator in a receiver summing element;
said receiver summing element in communication with a demodulator the output of which is in communication with a block de-interleaver;
said block de-interleaver output in communication with a Viterbi decoder the output of which is in communication with a source decoder;
said source decoder output in communication with a D/A converter the output of which is in communication with an analog low pass filter; and
said analog low pass filter output in communication with a power amplifier the output of which is in communication with a headphone speaker.
